(19) United States
(12) Patent Application Publication
(10) Pub. No.: US 2021/0333998 A1
(43) Pub. Date: Oct. 28, 2021

(54) INFORMATION PROCESSING APPARATUS, INFORMATION PROCESSING METHOD AND COMPUTER READABLE MEDIUM

(71) Applicant: MITSUBISHI ELECTRIC CORPORATION, Tokyo (JP)

(72) Inventor: Kenzo YAMAMOTO, Tokyo (JP)

(73) Assignee: MITSUBISHI ELECTRIC CORPORATION, Tokyo (JP)

(21) Appl. No.: 17/366,342

(22) Filed: Jul. 2, 2021

Related U.S. Application Data
(63) Continuation of application No. PCT/JP2019/007312, filed on Feb. 26, 2019.

(51) Int. Cl. G06F 3/06; G06F 9/46

(52) U.S. Cl. CPC G06F 3/064; G06F 9/466; G06F 3/0673; G06F 3/0604

(57) ABSTRACT

A task graph debranching section (109) determines as a parallelizable number, the number of parallelization of processes which is possible at a time of executing a program. A schedule generation section (112) generates as a parallelization execution schedule, an execution schedule of the program at the time of executing the program. A display processing section (114) computes a parallelization execution time which is a time required for executing the program at a time of executing the program according to the parallelization execution schedule. Further, the display processing section (114) generates parallelization information indicating the parallelizable number, the parallelization execution schedule, and the parallelization execution time, and outputs the generated parallelization information.

### CROSS REFERENCE TO RELATED APPLICATIONS

This application is a Continuation of PCT International Application No. PCT/JP2019/007312 filed on Feb. 26, 2019, which is hereby expressly incorporated by reference into the present application.

### TECHNICAL FIELD

The present invention relates to parallel processing on a program.

### BACKGROUND ART

In order to realize scalability of calculation performance or capacity, it is effective to assign a program to a plurality of processor units and process the program in parallel. As one of such parallelization techniques, there is a technique described in Patent Literature 1. In the technique described in Patent Literature 1, tasks having parallelism are extracted from a program. Then, a processing time of each task is estimated. As a result, it is possible to fulfill assignments of the tasks according to characteristics of the processor units.

### CITATION LIST

### Patent Literature

Patent Literature 1: JP4082706B

### SUMMARY OF INVENTION

### Technical Problem

According to Patent Literature 1, it is possible to automatically parallelize the program. However, since improvement on the calculation performance by parallelization depends on independence of the tasks and control structures of the tasks in the program, there is a problem that a programmer needs to perform coding while considering the parallelism.

For example, if the programmer generates a program in which the independence of the tasks is low without considering the parallelism, portions with which each processor unit can operate independently are limited even if the parallelization is performed. Therefore, communication for synchronization between the processor units frequently occurs, and the calculation performance is not improved.

Particularly, in a system such as a PLC (Programmable Logic Controller), since each of a plurality of processor units has a memory, an overhead due to the communication for synchronization becomes large. For this reason, in a system such as the PLC, a degree of the improvement on the calculation performance by the parallelization largely depends on the independence of the tasks and the control structures of the tasks in the program.

The present invention mainly aims to obtain a configuration for realizing efficient parallelization of a program.

### Solution to Problem

An information processing apparatus according to the present invention includes:

a determination section to determine as a parallelizable number, the number of parallelization of processes which is possible at a time of executing a program,

a schedule generation section to generate as a parallelization execution schedule, an execution schedule of the program at the time of executing the program;

a computation section to compute a parallelization execution time which is a time required for executing the program at a time of executing the program according to the parallelization execution schedule; and

an information generation section to generate parallelization information indicating the parallelizable number, the parallelization execution schedule, and the parallelization execution time, and output the generated parallelization information.

### Advantageous Effects of Invention

In the present invention, parallelization information indicating a parallelizable number, a parallelization execution schedule, and a parallelization execution time is output. Therefore, by referring to the parallelization information, a programmer can recognize the number of parallelization which is possible in a program currently being generated, a state of improvement on calculation performance by parallelization, and a potion that influences improvement on the calculation performance in the program. Therefore, it is possible to realize efficient parallelization.

### BRIEF DESCRIPTION OF DRAWINGS

FIG. 1 is a diagram illustrating a configuration example of a system according to a first embodiment;

FIG. 2 is a diagram illustrating a hardware configuration example of an information processing apparatus according to the first embodiment;

FIG. 3 is a diagram illustrating a functional configuration example of the information processing apparatus according to the first embodiment;

FIG. 4 is a flowchart illustrating an operation example of the information processing apparatus according to the first embodiment;

FIG. 5 is a diagram illustrating an example of a program according to the first embodiment;

FIG. 6 is a diagram illustrating an example of parallelization information according to the first embodiment;

FIG. 7 is a flowchart illustrating an operation example of an information processing apparatus according to a second embodiment;

FIG. 8 is a flowchart illustrating an operation example of an information processing apparatus according to a third embodiment;

FIG. 9 is a diagram illustrating an example of parallelization information according to the third embodiment;

FIG. 10 is a flowchart illustrating an extraction procedure of common devices according to the first embodiment;

FIG. 11 is a diagram illustrating an example of appearance of instructions and device names for each block according to the first embodiment; and

FIG. 12 is a diagram illustrating a procedure of extracting dependence relations according to the first embodiment.

### DESCRIPTION OF EMBODIMENTS

Hereinafter, embodiments of the present invention will be described with reference to the drawings. In the following description of the embodiments and the drawings, parts with the same reference numerals indicate the same or corresponding parts.

### First Embodiment

### Description of Configuration

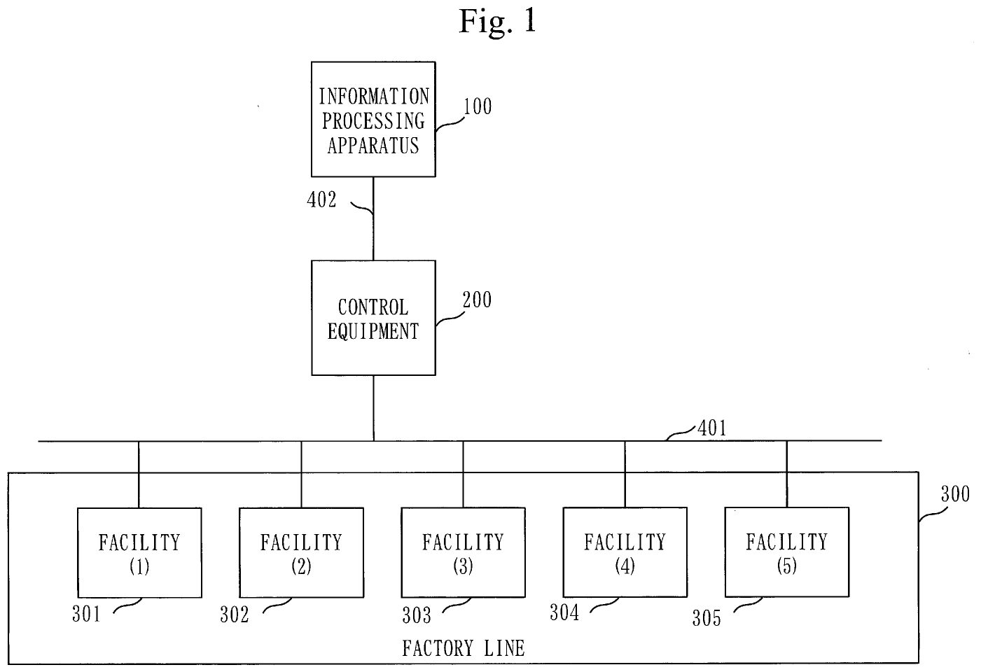

FIG. 1 illustrates a configuration example of a system according to the present embodiment.

A system according to the present embodiment is configured with an information processing apparatus 100, control equipment 200, a facility (1) 301, a facility (2) 302, a facility (3) 303, a facility (4) 304, a facility (5) 305, and a network 401, and a network 402.

The information processing apparatus 100 generates a program for controlling the facility (1) 301 to the facility (5) 305. The information processing apparatus 100 transmits the generated program to the control equipment 200 via the network 402.

Note that, operation performed by the information processing apparatus 100 is equivalent to an information processing method and an information processing program.

The control equipment 200 executes the program generated by the information processing apparatus 100, transmits control commands to the facility (1) 301 to the facility (5) 305 via the network 401, and controls the facility (1) 301 to the facility (5) 305.

The control equipment 200 is, for example, a PLC. Further, the control equipment 200 may be a general PC (Personal Computer).

The facility (1) 301 to the facility (5) 305 are manufacturing facilities placed in a factory line 300.

Although five facilities are illustrated in FIG. 1, the number of facilities placed in the factory line 300 is not limited to five.

The network 401 and the network 402 are, for example, field networks such as CC-Link. Further, the network 401 and the network 402 may be general networks such as Ethernet (registered trademark), or dedicated networks. Further, each of the network 401 and the network 402 may be a different type of network.

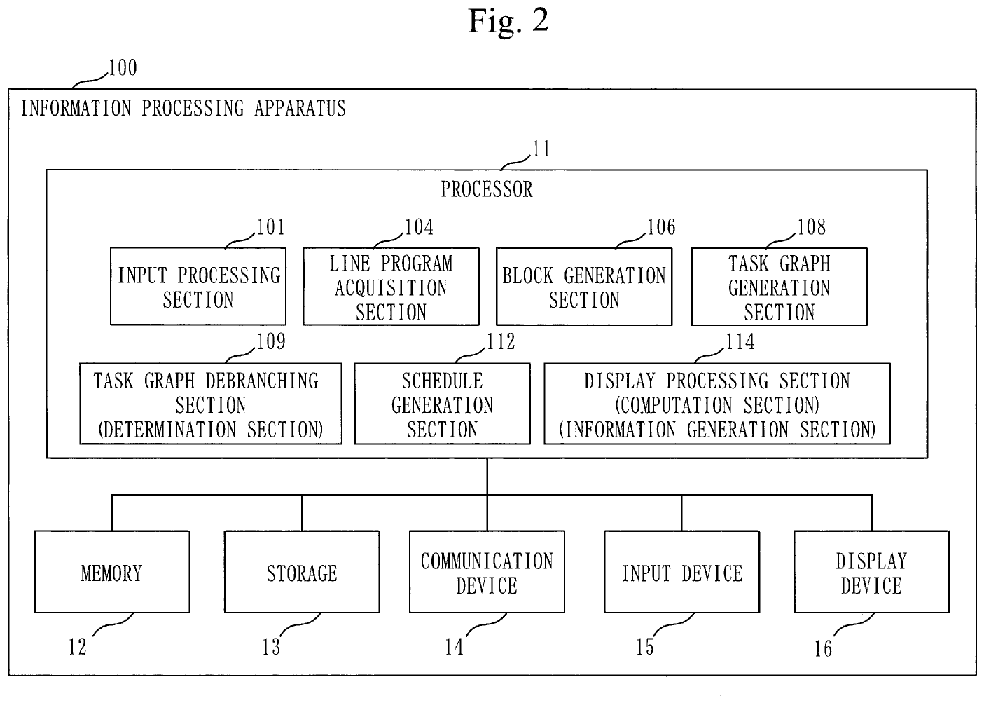

FIG. 2 illustrates a hardware configuration example of the information processing apparatus 100.

The information processing apparatus 100 is a computer, and a software configuration of the information processing apparatus 100 can be realized by a program. As a hardware configuration of the information processing apparatus 100, a processor 11, a memory 12, a storage 13, a communication device 14, an input device 15, and a display device 16 are connected to a bus.

The processor 11 is, for example, a CPU (Central Processing Unit).

The memory 12 is, for example, a RAM (Random Access Memory).

The storage 13 is, for example, a hard disk device, an SSD, or a memory card reading/writing device.

The communication device 14 is a communication board for a field network purpose such as an Ethernet (registered trademark) communication board or CC-Link.

The input device 15 is, for example, a mouse or a keyboard.

The display device 16 is, for example, a display.

Further, a touch panel obtained by combining the input device 15 and the display device 16 may be used.

The storage 13 stores programs that realize functions of an input processing section 101, a line program acquisition section 104, a block generation section 106, a task graph generation section 108, a task graph debranching section 109, a schedule generation section 112, and a display processing section 114, which will be described later.

These programs are loaded from the storage 13 into the memory 12. Then, the processor 11 executes these programs and performs operation of the input processing section 101, the line program acquisition section 104, the block generation section 106, the task graph generation section 108, the task graph debranching section 109, the schedule generation section 112, and the display processing section 114, which will be described later.

FIG. 2 schematically illustrates a state where the processor 11 executes the programs that realize the functions of the input processing section 101, the line program acquisition section 104, the block generation section 106, the task graph generation section 108, the task graph debranching section 109, the schedule generation section 112, and the display processing section 114.

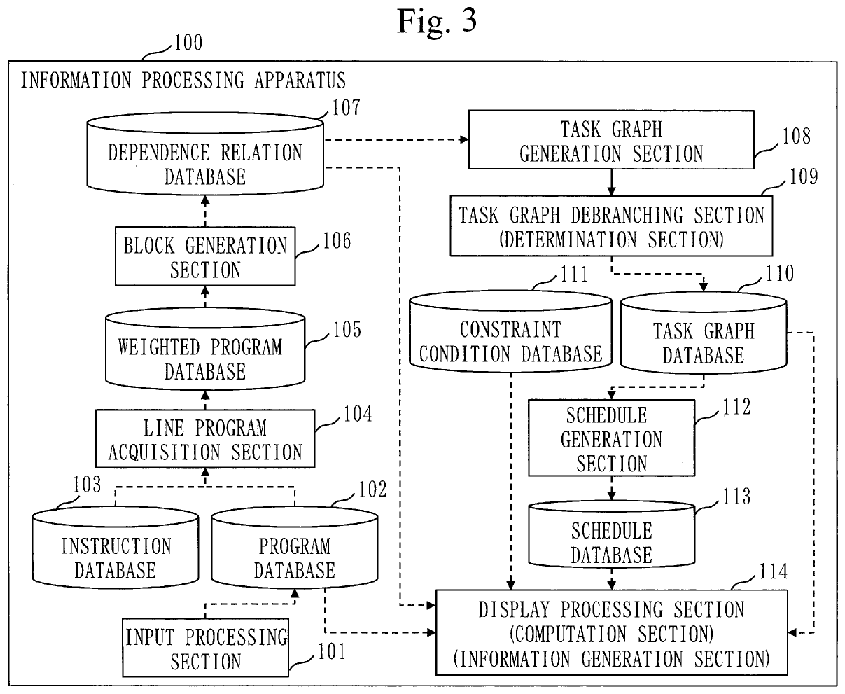

FIG. 3 illustrates a functional configuration example of the information processing apparatus 100. Note that, an arrow with a solid line in FIG. 3 indicates a calling relation, and arrows with dashed lines indicate flows of data with databases.

The input processing section 101 monitors a specific area on the display device 16, and stores in a program database 102, a program in the storage 13 when an action (a click by a mouse, or the like) is detected via the input device 15.

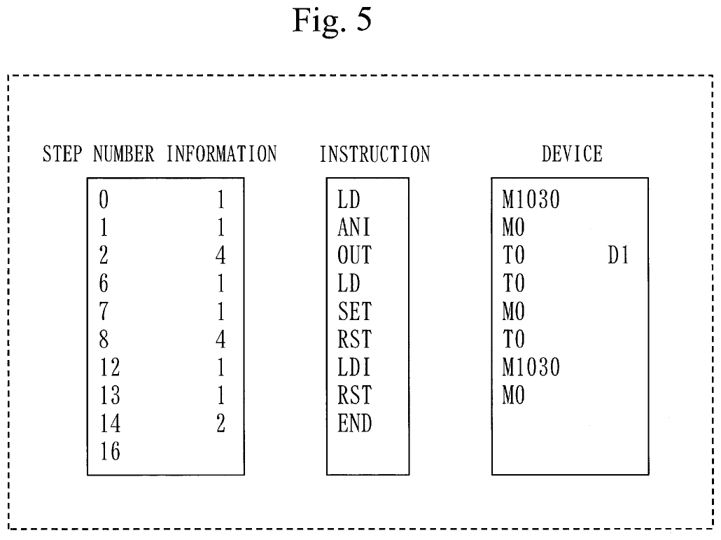

In the present embodiment, the input processing section 101 stores a program exemplified in FIG. 5 from the storage 13 into the program database 102.

In the program in FIG. 5, a first argument and a second argument are step number information. Further, in the program in FIG. 5, a third argument is an instruction, and fourth and subsequent arguments are devices. A step number is a numerical value which serves as an index for measuring a scale of the program. The instruction is a character string which defines operation to be performed by the processor of the control equipment 200. Note that, the device is a variable which is subject to the instruction.

The line program acquisition section 104 acquires each line of the program from the program database 102. A program of one line is referred to as a line program below. Further, the line program acquisition section 104 acquires the instruction and the device from the line program acquired. Further, the line program acquisition section 104 acquires from an instruction database 103, a type of the acquired instruction, an execution time, a head flag, and an end flag.

In the instruction database 103, the type of the instruction, the execution time, the head flag, and the end flag are defined for each line program.

The type of the instruction indicates whether the instruction of the line program is a reference instruction or a write instruction.

The execution time indicates a time required for executing the line program.

The head flag indicates whether or not the line program is located at a head of a block which will be described later. That is, the line program whose head flag is “1” is located at the head of the block.

The end flag indicates whether or not the line program is located at the end of the block. That is, the line program whose end flag is “1” is located at the end of the block.

Then, the line program acquisition section 104 stores the line program, the device, the type of the instruction, the execution time, the head flag, and the end flag in a weighted program database 105.

The block generation section 106 acquires the line program, the device, the type of the instruction, the execution time, the head flag, and the end flag from the weighted program database 105.

Then, the block generation section 106 groups a plurality of line programs based on the head flag and the end flag to configure one block.

That is, the block generation section 106 groups the line program whose head flag is “1” to the line program whose end flag is “1”, to generate one block.

As a result of generation of the block by the block generation section 106, the program is divided into a plurality of blocks.

Further, the block generation section 106 determines a dependence relation between the blocks. Details of the dependence relation between the blocks will be described later.

Further, the block generation section 106 generates block information indicating for each block, the line programs included in the block, and the device, the type of the instruction, and the execution time of the line program included in the block, and dependence relation information indicating the dependence relation between the blocks.

Then, the block generation section 106 stores the block information and the dependence relation information in a dependence relation database 107.

The task graph generation section 108 acquires the block information and the dependence relation information from the dependence relation database 107, refers to the block information and the dependence relation information, and generates a task graph.

The task graph debranching section 109 debrancher the task graph generated by the task graph generation section 108. That is, the task graph debranching section 109 organizes the dependence relations between the blocks and generates the task graph after deletion of an unnecessary route between the task graphs.

Further, the task graph debranching section 109 analyzes the task graph after debranching and determines as a parallelizable number, the number of parallelization of processes which is possible at a time of executing the program. More specifically, the task graph debranching section 109 determines the parallelizable number according to the maximum number of connections among the numbers of connections between the blocks in the task graph after debranching.

The task graph debranching section 109 stores in a task graph database 110, the task graph after debranching and the parallelizable number information indicating the parallelizable number.

Note that, the task graph debranching section 109 is equivalent to the determination section. Further, a process performed by the task graph debranching section 109 is equivalent to a determination process.

The schedule generation section 112 acquires from the task graph database 110, the task graph after debranching. Then, the schedule generation section 112 generates an execution schedule for the program at a time of executing the program, from the task graph after debranching. The schedule generated by the schedule generation section 112 is referred to as a parallelization execution schedule. The parallelization execution schedule is sometimes simply referred to as a schedule.

In the present embodiment, the schedule generation section 112 generates a Gantt chart indicating the parallelization execution schedule.

The schedule generation section 112 stores the generated Gantt chart in a schedule database 113.

Note that, a process performed by the schedule generation section 112 is equivalent to a schedule generation process.

The display processing section 114 acquires the Gantt chart from the schedule database 113.

Then, the display processing section 114 computes a parallelization execution time which is a time required for executing the program at a time of executing the program according to the parallelization execution schedule.

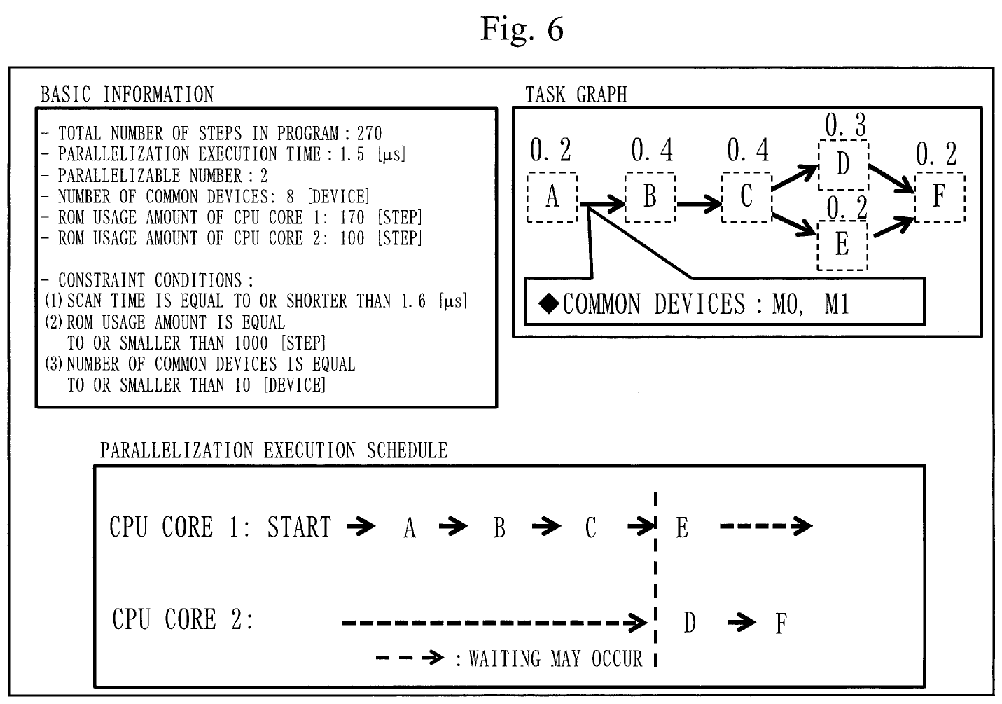

Further, the display processing section 114 generates parallelization information. For example, the display processing section 114 generates the parallelization information illustrated in FIG. 6. The parallelization information in FIG. 6 is configured with basic information, the task graph, and the parallelization execution schedule (Gantt chart). Details of the parallelization information in FIG. 6 will be described later.

The display processing section 114 outputs the generated parallelization information to the display device 16.

Note that, the display processing section 114 is equivalent to a computation section and an information generation section. Further, a process performed by the display processing section 114 is equivalent to a computation process and an information generation process.

### Description of Operation

Next, an operation example of the information processing apparatus 100 according to the present embodiment will be described with reference to a flowchart in

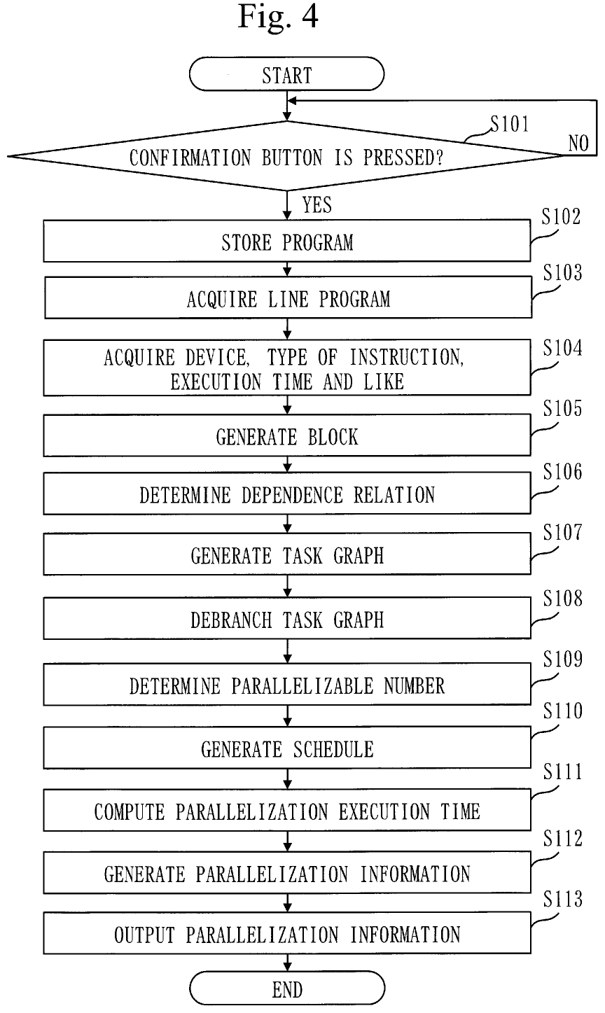

FIG. 4.

The input processing section 101 monitors an area where a confirmation button is displayed, on the display device 16, and determines whether or not the confirmation button is pressed via the input device 15 (whether or not there is a click by a mouse, or the like) (step S101). The input processing section 101 determines whether or not the confirmation button is pressed at constant intervals such as every second, every minute, every hour, and every day.

When the confirmation button is pressed (YES in step S101), the input processing section 101 stores in the program database 102, the program in the storage 13 (step S102).

Next, the line program acquisition section 104 acquires the line program from the program database 102 (step S103).

That is, the line program acquisition section 104 acquires each line of the program from the program database 102.

Further, the line program acquisition section 104 acquires the device, the type of the instruction, the execution time, and the like for each line program (step S104).

That is, the line program acquisition section 104 acquires the device from the line program acquired in step S103. Further, the line program acquisition section 104 acquires from the instruction database 103, the type of the instruction, the execution time, the head flag, and the end flag corresponding to the line program acquired in step S103.

As described above, in the instruction database 103, the type of the instruction, the execution time, the head flag, and the end flag are defined for each line program. Therefore, the line program acquisition section 104 can acquire from the instruction database 103, the type of the instruction, the execution time, the head flag, and the end flag corresponding to the line program acquired in step S103.

Then, the line program acquisition section 104 stores the line program, the device, the type of the instruction, the execution time, the head flag, and the end flag in the weighted program database 105.

The line program acquisition section 104 repeats step S103 and step S104 for all lines of the program.

Next, the block generation section 106 acquires the line program, the device, the type of the instruction, the execution time, the head flag, and the end flag from the weighted program database 105.

Then, the block generation section 106 generates the block (step S105).

More specifically, the block generation section 106 groups the line program whose head flag is “1” to the line program whose end flag is “1”, to generate one block.

The block generation section 106 repeats step S105 until the entire program is divided into the plurality of blocks.

Next, the block generation section 106 determines the dependence relation between the blocks (step S106).

In the present embodiment, extraction of the dependence relation is performed by labeling a content of an instruction word and a device name corresponding to the instruction word. Ensuring with this procedure that an execution order which needs to be observed is observed requires observing the execution order of the device (hereinafter, referred to as common device) used in a plurality of blocks. Influence on the device varies depending on each instruction, and in the present embodiment, the block generation section 106 determines the influence on the device as follows.
contact instruction, comparison calculation instruction, and the like: input
output instruction, bit processing instruction, and the like: output

Here, the input is a process of reading the information of the device used in the instruction, and the output is a process of rewriting the information of the device used in the instruction.

In the present embodiment, the block generation section 106 performs the extraction of the dependence relation by categorizing the devices described in the program into a device used for the input and a device used for the output and labeling the devices.

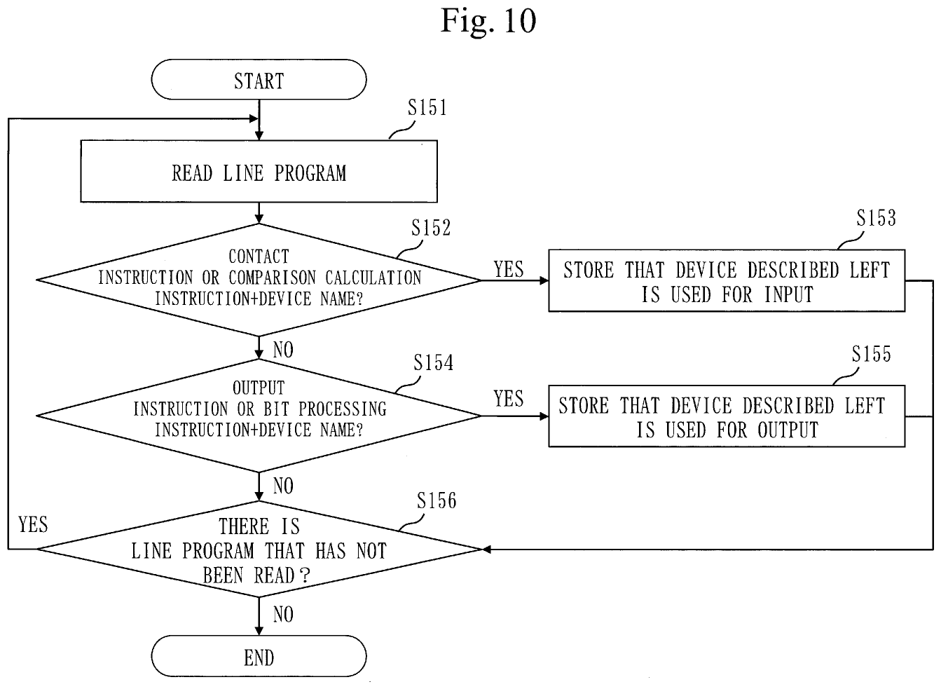

FIG. 10 illustrates an example of a flowchart of extracting the dependence relation in the common device.

In step S151, the block generation section 106 reads the line program from the head of the block.

In step S152, the block generation section 106 determines whether or not the device of the line program read in step S151 is the device used for the input. That is, the block generation section 106 determines whether or not the line program read in step S151 includes a description of “contact instruction+device name” or a description of “comparison calculation instruction+device name”.

If the line program read in step S151 includes the description of “contact instruction+device name” or the description of “comparison calculation instruction+device name” (YES in step S152), the block generation section 106 stores in a specified storage area that the device of the line program read in S151 is the device used for the input.

On the other hand, if the line program read in step S151 does not include any of the description of “contact instruction+device name” and the description of “comparison calculation instruction+device name” (NO in step S152), in step S154, the block generation section 106 determines whether or not the device of the line program read in step S151 is the device used for the output. That is, the block generation section 106 determines whether or not the line program read in step S151 includes a description of “output instruction+device name” or a description of “bit processing instruction+device name”.

If the line program read in step S151 includes the description of “output instruction+device name” or the description of “bit processing instruction+device name” (YES in step S154), the block generation section 106 stores in a specified storage area that the device of the line program read in step S151 is the device used for the output.

On the other hand, if the line program read in step S151 does not include any of the description of “output instruction+device name” and the description of “bit processing instruction+device name” (NO in step S154), in step S156, the block generation section 106 determines whether or not there is a line program that has not been read yet.

If there is the line program that has not been read yet (YES in step S156), the process returns to step S151. On the other hand, when all the line programs have been read (NO in step S156), the block generation section 106 ends the process.

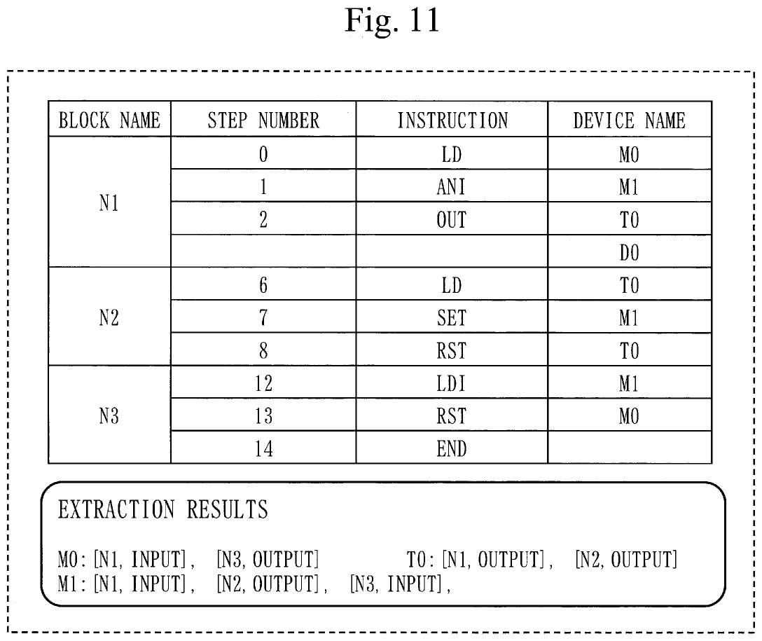

FIG. 11 illustrates an appearance example of the instructions and the device names for each block.

Focusing on a first line of a block name: N1 in FIG. 11, LD is used for the instruction, and M0 is used for the device name. Since the LD is the contact instruction, it is stored that the device M0 is used as the input in a block N1. By performing the same process on all the lines, extraction results illustrated in a lower part in FIG. 11 can be obtained.

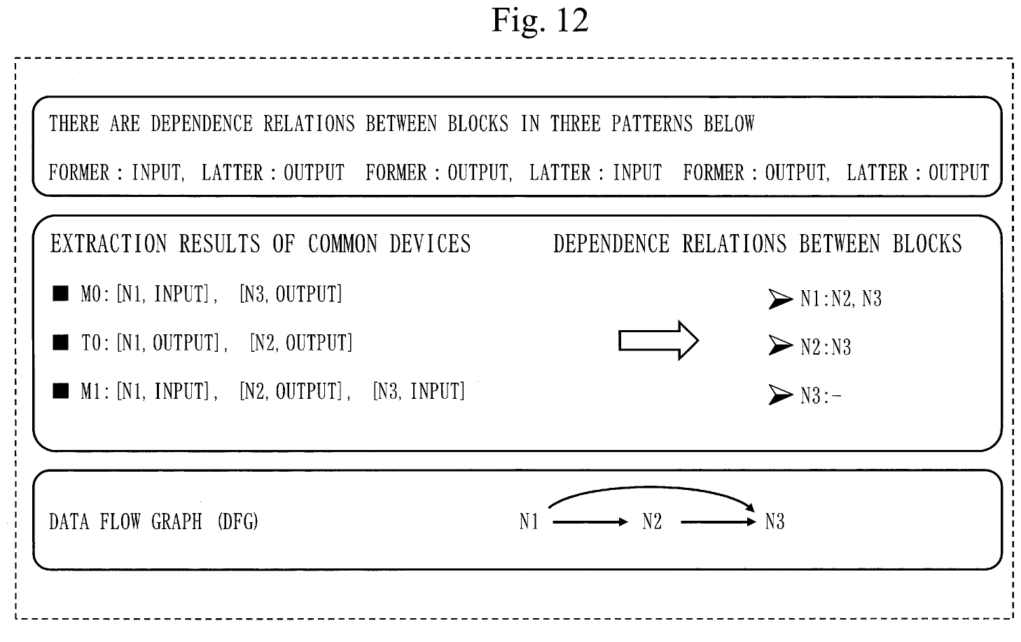

FIG. 12 illustrates a method of extracting the dependence relations between the blocks and examples of the dependence relations.

If there are following cases as to the common device, the block generation section 106 determines that there is the dependence relation between the blocks.
former: input, latter: output
former: output, latter: input
former: output, latter: output

Note that, “former” means a block which is prior in the execution order, among the blocks in which the common device is used. Further, “latter” means a block which is posterior in the execution order, among the blocks in which the common device is used.

As to a specific common device, when two blocks to be compared with each other are both inputs, a value of the common device to be referred to is the same value. Therefore, even if the execution order is changed, an execution result is not influenced (N1 and N3 in M1 in FIG. 12). On the other hand, in a case of the above three patterns, the value of the common device to be referred to changes, therefore, an unintended execution result is emerged if the execution order is changed. For example, focusing on the common device M0 in FIG. 12, the common device M0 is used as the input in the block N1 and as the output in the block N3. Therefore, there is the dependence relation between the block N1 and the block N3. By performing the same process for all common devices, the dependence relations between the blocks in FIG. 12 can be obtained.

A data flow graph (DFG) can be obtained by connecting blocks with each other that are in the dependence relation, based on the dependence relation between the blocks.

Next, the block generation section 106 stores the block information and the dependence relation information in the dependence relation database 107.

As described above, in the block information, the line program included in the block, the device of the line program included in the block, the type of the instruction, and the execution time are indicated for each block. The dependence relation information indicates the dependence relations between the blocks.

Next, the task graph generation section 108 generates a task graph indicating a process flow between the blocks (step S107).

The task graph generation section 108 acquires the block information, the parallelizable number information, and the dependence relation information from the dependence relation database 107, and generates the task graph by referring to the block information, the parallelizable number information, and the dependence relation information.

Next, the task graph debranching section 109 debranches the task graph generated in step S107 (step S108).

That is, the task graph debranching section 109 deletes an unnecessary route in the task graph by organizing the dependence relations between the blocks in the task graph.

Next, the task graph debranching section 109 determines the parallelizable number (step S109).

The task graph debranching section 109 designates as the parallelizable number, the maximum number of connections among the numbers of connections between the blocks in the task graph after debranching. The number of connections is the number of subsequent blocks that are connected to one preceding block.

For example, in the task graph after debranching, when the preceding block A and the subsequent block B are connected, the preceding block A and the subsequent block C are connected, and the preceding block A and the subsequent block D are connected, the number of connections is three. Then, if three being the number of connections is the maximum number of connections in the task graph after debranching, the task graph debranching section 109 determines that the parallelizable number is three.

In this way, the task graph debranching section 109 determines the parallelizable number among a plurality of blocks included in the program.

The task graph debranching section 109 stores in the task graph database 110, the task graph after debranching and the parallelizable number information indicating the parallelizable number.

Next, the schedule generation section 112 generates the parallelization execution schedule (step S110).

More specifically, the schedule generation section 112 refers to the task graph after debranching, and by using a scheduling algorithm, generates the parallelization execution schedule (Gantt chart) at a time of executing the program with the number of CPU cores designated by a programmer. The schedule generation section 112 extracts, for example, a critical path, and generates the parallelization execution schedule (Gantt chart) in such a manner that the critical path is displayed in red.

The schedule generation section 112 stores the generated parallelization execution schedule (Gantt chart) in the schedule database 113.

Next, the display processing section 114 computes the parallelization execution time (step S111).

More specifically, the display processing section 114 acquires the schedule (Gantt chart) from the schedule database 113, and also acquires the block information from the dependence relation database 107. Then, the display processing section 114 refers to the block information, integrates the execution times of the line programs for each block, to compute the execution time of each block. Then, the display processing section 114 integrates the execution time of each block according to the schedule (Gantt chart), and obtains the execution time (parallelization execution time) at the time of executing the program with the number of CPU cores designated by the programmer.

Next, the display processing section 114 generates the parallelization information (step S112).

For example, the display processing section 114 generates the parallelization information illustrated in FIG. 6.

Finally, the display processing section 114 outputs the parallelization information to the display device 16 (step S113). As a result, the programmer can refer to the parallelization information.

Here, the parallelization information illustrated in FIG. 6 will be described.

The parallelization information in FIG. 6 is configured with the basic information, the task graph, and the parallelization execution schedule (Gantt chart).

The basic information indicates the total number of steps in the program, the parallelization execution time, the parallelizable number, and constraint conditions.

The total number of steps in the program is a total value of the numbers of steps indicated in the step number information illustrated in FIG. 5. The display processing section 114 can obtain the total number of steps by acquiring the block information from the dependence relation database 107 and referring to the step number information of the line program included in the block information.

Further, the parallelization execution time is a value obtained in step S111.

The parallelizable number is a value obtained in step S107. The display processing section 114 can obtain the parallelizable number by acquiring the parallelizable number information from the task graph database 110 and referring to the parallelizable number information.

Further, the number of common devices extracted according to the procedure in FIG. 10 may be included in the parallelization information.

Further, the display processing section 114 may compute the number of ROM usages for each CPU core and include the computed number of ROM usages of each CPU core in the parallelization information. The display processing section 114 obtains the step number for each block, for example, by referring to the step number information of the line program included in the block information. Then, the display processing section 114 obtains the number of ROM usages of each CPU core by integrating for each CPU core indicated in the parallelization execution schedule (Gantt chart), the step number in the corresponding block.

The constraint condition defines required values for the program. In an example in FIG. 6, “scan time is equal to or shorter 1.6 [μs]” is defined as a required value for the parallelization execution time. Further, “a ROM usage amount is equal to or smaller than 1000 [STEP]” is defined as a required value for the number of steps (a memory usage amount). Further, “the number of common devices is equal to or smaller than 10 [devices]” is defined as a required value for the common device.

The display processing section 114 acquires the constraint conditions from a constraint condition database 111.

The task graph is the task graph after debranching which is generated in step S109.

The display processing section 114 acquires the task graph after debranching from the task graph database 110.

In FIG. 6, each of “A” to “F” indicates a block. Further, “0.2”, “0.4”, and the like illustrated above the displayed blocks are the execution time in a unit of the block.

Further, as illustrated in FIG. 6, the common device may be indicated overlappingly on the task graph. The example in FIG. 6 illustrates that the device “M0” and the device “M1” are used in common in the block A and the block B.

The parallelization execution schedule (Gantt chart) is generated in step S110. The display processing section 114 acquires the parallelization execution schedule (Gantt chart) from the schedule database 113.

### Description of Effect of Embodiment

As described above, in the present embodiment, the parallelization information configured with the parallelization execution time, the parallelizable number, the parallelization execution schedule, and the like is displayed. Therefore, a programmer can recognize the parallelization execution time and the parallelizable number of the program currently being generated, by referring to the parallelization information. Further, the programmer can consider whether or not the parallelization currently under consideration is sufficient. Further, the programmer can recognize a state of improvement on the calculation performance by the parallelization and a portion in the program that influences an improvement on the calculation performance, according to the parallelization execution schedule. As described above, according to the present embodiment, it is possible to provide the programmer with a guideline for improvement on the parallelization, and to realize efficient parallelization.

Note that, in the above, an example of applying the flow in FIG. 4 to the whole program has been described. Instead of this, the flow in FIG. 4 may be applied only to a difference between the programs. For example, when a programmer modifies the program, the line program acquisition section 104 extracts a difference between the program before modification and the program after the modification. Then, the processes of and after step S103 in FIG. 4 may be performed only on an extracted difference.

### Second Embodiment

In the present embodiment, differences from the first embodiment will be mainly described.

Note that, matters not described below are the same as those in the first embodiment.

### Description of Configuration

A system configuration according to the present embodiment is as illustrated in FIG. 1.

A hardware configuration example of the information processing apparatus 100 according to the present embodiment is as illustrated in FIG. 2.

A functional configuration example of the information processing apparatus 100 according to the present embodiment is as illustrated in FIG. 3.

### Description of Operation

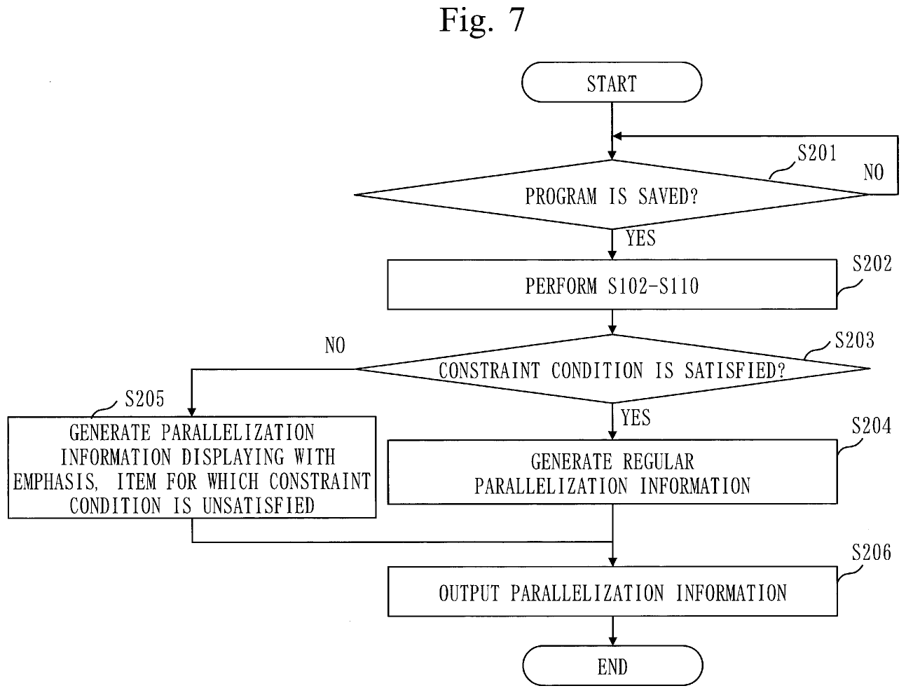

FIG. 7 illustrates an operation example of the information processing apparatus 100 according to the present embodiment.

The operation example of the information processing apparatus 100 according to the present embodiment will be described with reference to FIG. 7.

In the present embodiment, the input processing section 101 determines whether or not a programmer saves the program, using the input device 15 (step S201).

When the program is saved (YES in step S201), the processes described in step S102 to step S110 illustrated in FIG. 4 are performed (step S202).

Since the processes of steps S102 to S110 are as described in the first embodiment, descriptions will be omitted.

After step S110 is performed and the parallelization execution time is computed, the display processing section 114 determines whether or not the constraint condition is satisfied (step S203).

For example, when the constraint conditions described in the basic information in FIG. 6 are used, the display processing section 114 determines whether or not the parallelization execution time satisfies a required value (“scan time is equal to or shorter than 1.6 [μs]”) of a scan time described in the constraint conditions. Further, the display processing section 114 determines whether or not the total number of steps in the program satisfies a required value (“the ROM usage amount is equal to or smaller than 1000 [STEP]”) of the ROM usage amount described in the constraint conditions. Further, the display processing section 114 determines whether or not the number of common devices satisfies a required value (“the number of common devices is equal to or smaller than 10 [devices]”) for the common devices described in the constraint conditions.

When all the constraint conditions are satisfied (YES in step S203), the display processing section 114 generates regular parallelization information (step S204).

On the other hand, when even one constraint condition is unsatisfied (NO in step S203), the display processing section 114 generates the parallelization information displaying with an emphasis, an item for which the constraint condition is unsatisfied (step S205).

For example, when “scan time is equal to or shorter than 1.6 [μs]” in FIG. 6 is unsatisfied, the display processing section 114 generates parallelization information displaying in red, “parallelization execution time” which is an item corresponding to the constraint condition.

Note that, if “scan time is equal to or shorter than 1.6 [μs]” in FIG. 6 is unsatisfied, the display processing section 114 may, for example, generate the parallelization information displaying in blue, a block which is a cause of being unsatisfied, on the parallelization execution schedule (Gantt chart).

Further, for example, when “the ROM usage amount is equal to or smaller than 1000 [STEP]” in FIG. 6 is unsatisfied, the display processing section 114 generates the parallelization information displaying in red, “total number of steps in the program” which is an item corresponding to the constraint condition.

Further, for example, when “the number of common devices is equal to or smaller than 10 [devices]” in FIG. 6 is unsatisfied, the display processing section 114 generates the parallelization information displaying in red, “the number of common devices” which is an item corresponding to the constraint condition.

After that, the display processing section 114 outputs the parallelization information generated in step S204 or step S205 to the display device 160 (step S206).

Further, if the constraint condition is unsatisfied, the display processing section 114 may display in blue, a program code of a block which is a cause of being unsatisfied.

### Description of Effect of Embodiment

According to the present embodiment, since the parallelization information displaying with an emphasis, the item for which the constraint condition is unsatisfied is displayed, it enables a programmer to recognize an item which should be improved and it is possible to shorten a time required for debugging the program.

Note that, in the above, an example has been described in which detection of saving of the program (step S201 in FIG. 7) servers as a trigger for the process. However, detection (step S101 in FIG. 4) of pressing the confirmation button may serve as the trigger for the process as with the first embodiment.

Further, every time the programmer generates one line of the program, the processes of and after step S202 in FIG. 7 may start.

Further, the processes of and after step S202 in FIG. 7 may start at constant time intervals (for example, one minute). Further, the processes of and after step S202 in FIG. 7 may start triggered by a fact that the programmer inserts a specific program component (contact instruction or the like) into the program.

### Third Embodiment

In the present embodiment, differences between the first embodiment and the second embodiment will be mainly described.

Note that, matters not described below are the same as those in the first embodiment or the second embodiment.

### Description of Configuration

A system configuration according to the present embodiment is as illustrated in FIG. 1.

A hardware configuration example of the information processing apparatus 100 according to the present embodiment is as illustrated in FIG. 2.

A functional configuration example of the information processing apparatus 100 according to the present embodiment is as illustrated in FIG. 3.

### Description of Operation

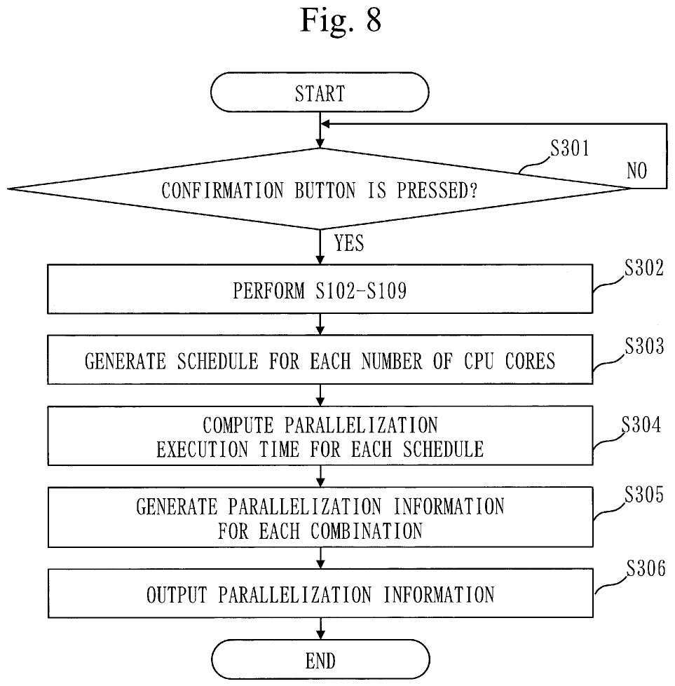

FIG. 8 illustrates an operation example of the information processing apparatus 100 according to the present embodiment.

The operation example of the information processing apparatus 100 according to the present embodiment will be described with reference to FIG. 8.

The input processing section 101 monitors an area where the confirmation button is displayed, on the display device 16 and determines whether or not the confirmation button is pressed (whether or not there is a click by a mouse, or the like) via the input device 15 (step S301).

When the confirmation button has been pressed (YES in step S301), the processes described in step S102 to step S109 illustrated in FIG. 4 are performed (step S302).

Since the processes of step S102 to step S109 are as illustrated in the first embodiment, descriptions will be omitted.

Next, the schedule generation section 112 generates the parallelization execution schedule (Gantt chart) for each number of CPU cores based on the task graph after debranching which is obtained in step S109 (step S303).

For example, if a programmer considers adoption of dual cores, triple cores, and quad cores, the schedule generation section 112 generates a parallelization execution schedule (Gantt chart) at a time of executing the program with the dual cores; a parallelization execution schedule (Gantt chart) at a time of executing the program with the triple cores, and a parallelization execution schedule (Gantt chart) at a time of executing the program with the quad cores.

Next, the display processing section 114 computes the parallelization execution time for each schedule generated in step S306 (step S304).

Next, the display processing section 114 generates the parallelization information for each combination (step S305).

The combination is a combination of the constraint condition and the number of CPU cores.

In the present embodiment, the programmer sets a plurality of patterns in variations of constraint conditions. For example, the programmer sets as a pattern 1, a pattern in which a required value for each of the scan time, the ROM usage amount, and the common device is mild. Further, the programmer sets as a pattern 2, a pattern in which a required value for the scan time is strict, but a required value for each of the ROM usage amount and the common device is mild. Further, the programmer sets as a pattern 3, a pattern in which a required value for each of the scan time, the ROM usage amount, and the common device is strict.

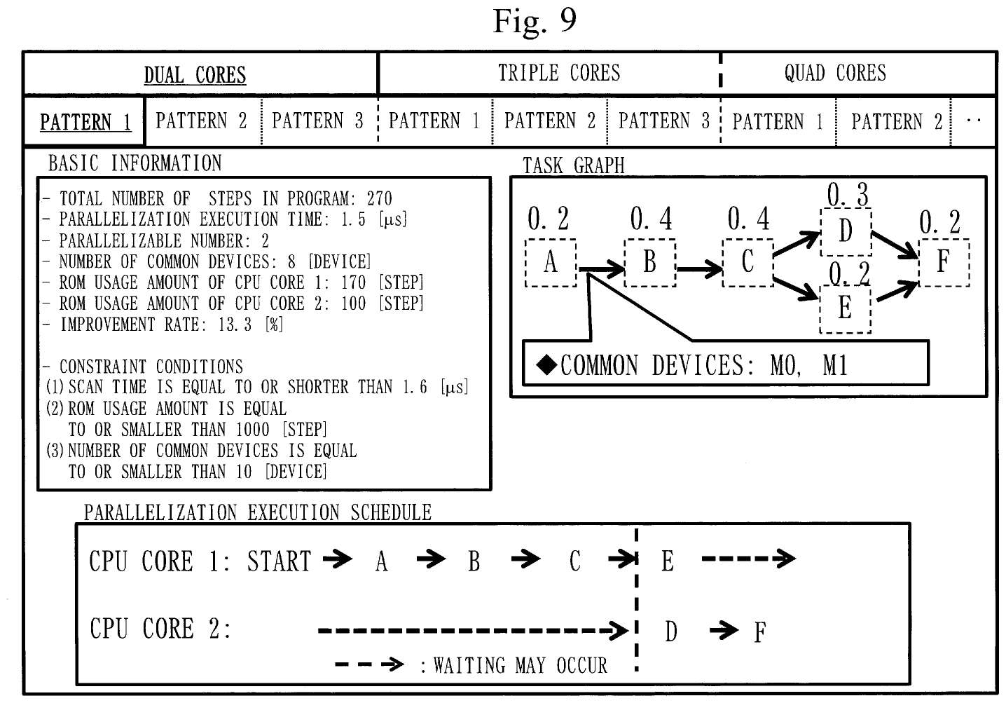

For example, as illustrated in FIG. 9, the display processing section 114 generates the parallelization information with: combinations of the dual cores and each of the pattern 1, the pattern 2, and the pattern 3; combinations of the triple cores and each of the pattern 1, the pattern 2, and the pattern 3; and combinations of the quad cores and each of the pattern 1, the pattern 2, and the pattern 3.

In the parallelization information illustrated in FIG. 9, a tab is provided for each combination of the number of cores and the pattern. For a desired combination, by clicking by a mouse on a tab of the desired combination, the programmer can refer to the parallelization execution schedule (Gantt chart), a state as to whether or not the constraint condition is satisfied, and the like. In an example in FIG. 9, the parallelization information for the combination of the dual cores and the pattern 1 is displayed.

Note that, if the numbers of cores are in common, the parallelization execution schedules (Gantt charts) are the same. That is, the parallelization execution schedules (Gantt charts) are the same, which are indicated in each of: the parallelization information corresponding to the combination of the dual cores and the pattern 1; the parallelization information corresponding to the combination of the dual cores and the pattern 2; and the parallelization information corresponding to the combination of the dual cores and the pattern 3.

On the other hand, descriptions of the basic information may be different in each pattern. The display processing section 114 determines for each pattern whether or not the constraint condition is satisfied. Then, the display processing section 114 generates the parallelization information in which the basic information indicates whether or not the constraint condition is satisfied for each pattern.

For example, in the combination of the dual cores and the pattern 2, it is assumed that the required value for the scan time is unsatisfied, and the required value for each of the ROM usage amount and the common device is satisfied. In this case, “parallelization execution time” which is an item corresponding to the constraint condition is displayed, for example, in red. Further, for example, in the combination of the dual cores and the pattern 3, it is assumed that the required value for each of the scan time, the ROM usage amount, and the common device is unsatisfied. In this case, an item corresponding to each of the scan time, the ROM usage amount, and the common device is displayed, for example, in red.

Further, the parallelization information illustrated in FIG. 9 indicates an improvement rate. The display processing section 114 computes a time (non-parallelization execution time) required for executing the program at a time of executing the program without the parallelization (at a time of executing the program with a single core). Then, the display processing section 114 computes the improvement rate as a state of difference between the time (parallelization execution time) required for executing the program at a time of executing the program according to the parallelization execution schedule, and the non-parallelization execution time. That is, the display processing section 114 obtains the improvement rate by calculating “{(non-parallelization execution time/parallelization execution time)-1}*100”. The display processing section 114 computes the improvement rate for each of the dual cores, the triple cores, and the quad cores, and displays the improvement rate in each parallelization information.

Finally, the display processing section 114 outputs the parallelization information to the display device 16 (step S309).

### Description of Effect of Embodiment

In the present embodiment, parallelization information is displayed for each combination of the number of CPU cores and the pattern of the constraint conditions. Therefore, according to the present embodiment, a programmer can early recognize the number of parallelization satisfying the constraint condition.

Although the embodiments of the present invention have been described above, two or more of these embodiments may be combined and implemented.

Alternatively, one of these embodiments may be partially implemented.

Alternatively, two or more of these embodiments may be partially combined and implemented.

Note that, the present invention is not limited to these embodiments, and various modifications can be made as necessary.

### Description of Hardware Configuration

Finally, supplementary descriptions of the hardware configuration of the information processing apparatus 100 will be given.

The storage 13 in FIG. 3 stores also an OS (Operating System) in addition to the programs that realize the functions of the input processing section 101, the line program acquisition section 104, the block generation section 106, the task graph generation section 108, the task graph debranching section 109, the schedule generation section 112, and the display processing section 114.

Then, at least a part of the OS is executed by the processor 11.

While executing at least the part of the OS, the processor 11 executes the programs that realize the functions of the input processing section 101, the line program acquisition section 104, the block generation section 106, the task graph generation section 108, the task graph debranching section 109, the schedule generation section 112, and the display processing section 114.

By the processor 11 executing the OS, task management, memory management, file management, communication control, and the like are performed.

Further, at least one of information, data, a signal value, and a variable value indicating a processing result of the input processing section 101, the line program acquisition section 104, the block generation section 106, the task graph generation section 108, the task graph debranching section 109, the schedule generation section 112, and the display processing section 114 is stored in at least one of the memory 12, the storage 13, and a register and a cache memory in the processor 11.

Further, the programs that realize the functions of the input processing section 101, the line program acquisition section 104, the block generation section 106, the task graph generation section 108, the task graph debranching section 109, the schedule generation section 112, and the display processing section 114 may be stored in a portable recording medium such as a magnetic disk, a flexible disk, an optical disk, a compact disk, a Blu-ray (registered trademark) disk, a DVD, or the like. Then, the portable recording medium storing the programs that realize the functions of the input processing section 101, the line program acquisition section 104, the block generation section 106, the task graph generation section 108, the task graph debranching section 109, the schedule generation section 112, and the display processing section 114 may be distributed commercially.

Further, “section” of the input processing section 101, the line program acquisition section 104, the block generation section 106, the task graph generation section 108, the task graph debranching section 109, the schedule generation section 112, and the display processing section 114 may be read as “circuit” or “step” or “procedure” or “process”.

Further, the information processing apparatus 100 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

In this case, each of the input processing section 101, the line program acquisition section 104, the block generation section 106, the task graph generation section 108, the task graph debranching section 109, the schedule generation section 112, and the display processing section 114 is realized as a part of the processing circuit.

Note that, in the present specification, a superordinate concept of the processor and the processing circuit is referred to as “processing circuitry”.

That is, each of the processor and the processing circuit is a specific example of the “processing circuitry”.

### REFERENCE SIGNS LIST

11: processor, 12: memory, 13: storage, 14: communication device, 15: input device, 16: display device, 100: information processing apparatus, 101: input processing section, 102: program database, 103: instruction database, 104: line program acquisition section, 105: weighted program database, 106: block generation section, 107: dependence relation database, 108: task graph generation section, 109: task graph debranching section, 110: task graph database, 111: constraint condition database, 112: schedule generation section, 113: schedule database, 114: display processing section, 200: control equipment, 300: factory line, 301: facility (1), 302: facility (2), 303: facility (3), 304: facility (4), 305: facility (5), 401: network, 402: network.

1. An information processing apparatus comprising:
processing circuitry
to determine as a parallelizable number, the number of parallelization of processes which is possible at a time of executing a program constituted of a plurality of blocks,
to generate as a parallelization execution schedule, an execution schedule of the program at the time of executing the program;
to compute a parallelization execution time which is a time required for executing the program at a time of executing the program according to the parallelization execution schedule; and
to generate parallelization information indicating the parallelizable number, the parallelization execution schedule, the parallelization execution time, the number of common variables which is the number of variables used in common in two or more blocks among the plurality of blocks, and a memory usage amount at the time of executing the program, and output the generated parallelization information.

2. The information processing apparatus according to claim 1,
wherein the processing circuitry generates based on a dependence relation between blocks among the plurality of blocks which constitute the program, a task graph of the plurality of blocks, and determines the parallelizable number by analyzing the task graph.

3. The information processing apparatus according to claim 2,
wherein the processing circuitry performs debranching of the task graph and determines the parallelizable number according to the maximum number of connections among the numbers of connections between the blocks in a task graph after the debranching.

4. The information processing apparatus according to claim 3,
wherein the processing circuitry generates the parallelization information indicating the task graph after the debranching.

5. The information processing apparatus according to claim 1,
wherein the processing circuitry generates the parallelization information indicating a required value for the parallelization execution time.

6. The information processing apparatus according to claim 5,
wherein the processing circuitry generates the parallelization information indicating whether or not the parallelization execution time satisfies the required value.

7. The information processing apparatus according to claim 1,
wherein the processing circuitry generates the parallelization information indicating whether or not the number of common variables satisfies a required value for the number of common variables, and indicating whether or not the memory usage amount satisfies a required value for the memory usage amount.

8. The information processing apparatus according to claim 1,
wherein the processing circuitry
generates the parallelization execution schedule for each number of CPU (Central Processing Unit) cores which is the number of CPU cores which execute the program,
computes for each number of CPU cores, a parallelization execution time at a time of executing the program according to a corresponding parallelization execution schedule, and
generates for the number of CPU cores, the parallelization information indicating the parallelization execution schedule and the parallelization execution time.

9. The information processing apparatus according to claim 1,
wherein the processing circuitry generates the parallelization information indicating a plurality of required values for the parallelization execution time and indicating whether or not the parallelization execution time satisfies each of the required values.

10. The information processing apparatus according to claim 1,
wherein the processing circuitry generates the parallelization information indicating a plurality of required values for the number of common variables, indicating a plurality of required values for a memory usage amount at the time of executing the program, and indicating whether or not the number of common variables satisfies each of the required values, and whether or not the memory usage amount satisfies each of the required values.

11. The information processing apparatus according to claim 1,
wherein the processing circuitry
computes a non-parallelization execution time which is a time required for executing the program at a time of executing the program without parallelizing the processes, and
generates the parallelization information indicating a state of difference between the parallelization execution time and the non-parallelization execution time.

12. An information processing method comprising:
determining as a parallelizable number, the number of parallelization of processes which is possible at a time of executing a program constituted of a plurality of blocks,
generating as a parallelization execution schedule, an execution schedule of the program at the time of executing the program;
computing a parallelization execution time which is a time required for executing the program at a time of executing the program according to the parallelization execution schedule; and
generating parallelization information indicating the parallelizable number, the parallelization execution schedule, the parallelization execution time, the number of common variables which is the number of variables used in common in two or more blocks among the plurality of blocks, and a memory usage amount at the time of executing the program, and outputting the generated parallelization information.

13. A non-transitory computer readable medium storing an information processing program which causes a computer to execute:
a determination process of determining as a parallelizable number, the number of parallelization of processes which is possible at a time of executing a program constituted of a plurality of blocks,
a schedule generation process of generating as a parallelization execution schedule, an execution schedule of the program at the time of executing the program;
a computation process of computing a parallelization execution time which is a time required for executing the program at a time of executing the program according to the parallelization execution schedule; and
an information generation process of generating parallelization information indicating the parallelizable number, the parallelization execution schedule, the parallelization execution time, the number of common variables which is the number of variables used in common in two or more blocks among the plurality of blocks, and a memory usage amount at the time of executing the program, and outputting the generated parallelization information.
